(19) United States
(12) Patent Application Publication
(10) Pub. No.: US 2026/0010384 A1
(43) Pub. Date: Jan. 8, 2026

(54) APPLICATION-BASED SCREEN RECORDING

(71) Applicant: Tencent Technology (Shenzhen) Company Limited, Shenzhen (CN)

(72) Inventor: Qinjie ZHANG, Shenzhen (CN)

(73) Assignee: Tencent Technology (Shenzhen) Company Limited, Shenzhen (CN)

(21) Appl. No.: 19/325,403

(22) Filed: Sep. 10, 2025

Related U.S. Application Data
(63) Continuation of application No. PCT/CN2024/091618, filed on May 8, 2024.

(30) Foreign Application Priority Data
Jun. 20, 2023 (CN) 202310740938.6

(51) Int. Cl. G06F 9/451

(52) U.S. Cl. CPC G06F 9/451

(57) ABSTRACT

In a screen recording method, a recording application process corresponding to an application is executed. The recording application process includes a primary rendering thread, a secondary rendering thread, and an encoding thread. The secondary rendering thread and the encoding thread are enabled based on a screen recording operation. Through the primary rendering thread, rendering data stored in a back buffer of the primary rendering thread is copied to a bridge buffer. A shared texture identifier is bound to the bridge buffer. Through the secondary rendering thread, the rendering data from the bridge buffer is obtained based on the shared texture identifier. The rendering data is drawn onto an input rendering surface provided by the encoding thread to generate an output rendering surface. Through the encoding thread, the output rendering surface is encoded to generate video frame data.

### RELATED APPLICATIONS

The present application is a continuation of International Application No. PCT/CN2024/091618, filed on May 8, 2024, which claims priority to Chinese Patent Application No. 202310740938.6, filed on Jun. 20, 2023. The entire disclosures of the prior applications are hereby incorporated by reference.

### FIELD OF THE TECHNOLOGY

This application relates to the field of computer technologies, including screen recording technologies.

### BACKGROUND OF THE DISCLOSURE

Screen recording refers to a function of a terminal device for recording content displayed on a screen of the terminal device, to generate a corresponding video. With diverse development of Internet services, a screen recording function is widely applied to various scenarios, such as game live streaming and online conferencing.

In related technology, an application program (such as a game application program or a conference application program) having a screen recording requirement on a terminal device needs to record displayed content by using a screen recording capability provided by a system of the terminal device. For example, a screen rendering process in the system is called to record the displayed content.

However, the foregoing recording method can have the following problems: calling a screen rendering process in a system to record displayed content may record all displayed content on a screen, and in this case, recorded content not only includes displayed content of an application program required by a user and that has a screen recording requirement, but also includes displayed content or notification content of another application program on a terminal device that is not required by the user, and does not satisfy an actual screen recording requirement of the user. In addition, as all the displayed content on the screen is recorded, displayed content of another application program needs to be obtained. Therefore, the application program having the screen recording requirement further needs to apply for a system permission before screen recording, and screen recording is performed after the application program is authorized, causing complicated operations.

### SUMMARY

Aspects of this disclosure provide a screen recording method, an apparatus, and a non-transitory computer-readable storage medium, which can more effectively satisfy an actual screen recording requirement of a user, simplify an operation process of screen recording, and improve implementation efficiency of a screen recording function. Examples of technical solutions of this disclosure may be implemented as follows:

An aspect of this disclosure provides a screen recording method. In the method, a recording application process corresponding to an application is executed. The recording application process includes a primary rendering thread, a secondary rendering thread, and an encoding thread. The secondary rendering thread and the encoding thread are enabled based on a screen recording operation. Through the primary rendering thread, rendering data stored in a back buffer of the primary rendering thread is copied to a bridge buffer. A shared texture identifier is bound to the bridge buffer. Through the secondary rendering thread, the rendering data from the bridge buffer is obtained based on the shared texture identifier. The rendering data is drawn onto an input rendering surface provided by the encoding thread to generate an output rendering surface. Through the encoding thread, the output rendering surface is encoded to generate video frame data.

An aspect of this disclosure provides a screen recording apparatus. The apparatus includes processing circuitry configured to execute a recording application process corresponding to an application. The recording application process includes a primary rendering thread, a secondary rendering thread, and an encoding thread. The secondary rendering thread and the encoding thread are enabled based on a screen recording operation. The processing circuitry is configured to copy, through the primary rendering thread, rendering data stored in a back buffer of the primary rendering thread to a bridge buffer. A shared texture identifier is bound to the bridge buffer. The processing circuitry is configured to obtain, through the secondary rendering thread, the rendering data from the bridge buffer based on the shared texture identifier. The processing circuitry is configured to draw the rendering data onto an input rendering surface provided by the encoding thread to generate an output rendering surface. The processing circuitry is configured to encode, through the encoding thread, the output rendering surface to generate video frame data.

In view of this, an aspect of this disclosure provides a screen recording method. The method is performed by a computer device by using a recording application process corresponding to an application. The recording application process includes a primary rendering thread, a secondary rendering thread, and an encoding thread. The secondary rendering thread and the encoding thread are enabled in response to a screen recording operation triggered by using the application. The method includes: replicating, by using the primary rendering thread, rendering data stored in a backward buffer in the primary rendering thread to a bridge buffer, a shared texture identifier being bound to the bridge buffer; obtaining, by using the secondary rendering thread, the rendering data from the bridge buffer based on the shared texture identifier, drawing the rendering data onto an input rendering surface provided by the encoding thread, to obtain an output rendering surface, and transmitting the output rendering surface to the encoding thread; and performing, by using the encoding thread, encoding based on the output rendering surface, to obtain recorded video frame data.

An aspect of this disclosure provides a screen recording apparatus. The apparatus is deployed on a computer device, and supports running of a recording application process corresponding to an application. The recording application process includes a primary rendering thread, a secondary rendering thread, and an encoding thread. The secondary rendering thread and the encoding thread are enabled in response to a screen recording operation triggered by using the application. The apparatus includes: a data replication module, configured to replicate, by using the primary rendering thread, rendering data stored in a backward buffer in the primary rendering thread to a bridge buffer, a shared texture identifier being bound to the bridge buffer; a rendering module, configured to: obtain, by using the secondary rendering thread, the rendering data from the bridge buffer based on the shared texture identifier, draw the rendering data onto an input rendering surface provided by the encoding thread, to obtain an output rendering surface, and transmit the output rendering surface to the encoding thread; and an encoding module, configured to perform, by using the encoding thread, encoding based on the output rendering surface, to obtain recorded video frame data.

An aspect of this disclosure provides a computer device, including a processor and a memory.

The memory is configured to store a computer program.

The processor is configured to implement, based on the computer program, the screen recording method according to any of the aspects described herein.

An aspect of this disclosure provides a non-transitory computer-readable storage medium, having computer-executable instructions stored therein, the computer-executable instructions, when executed by a processor, cause the processor to implement the screen recording method according any of the aspects described herein.

An aspect of this disclosure provides a computer program product. The computer program product includes a computer program, and the computer program is stored in a computer-readable storage medium. A processor of a computer device reads the computer program from the computer-readable storage medium, and executes the computer program, so that the computer device performs operations of the screen recording method according to any of the aspects described herein.

According to the foregoing technical solutions, the aspects of this disclosure achieve at least the following beneficial effects:

Aspects of this disclosure provide a screen recording method. In this method, an independent recording application process is allocated to each application, so that a displayed image of the application is recorded by using the recording application process. Therefore, the screen recording method is applied to a recording application process corresponding to an application, where the recording application process includes a primary rendering thread, a secondary rendering thread, and an encoding thread, and the secondary rendering thread and the encoding thread are enabled in response to a screen recording operation triggered by using the application. The screen recording method includes: replicating, by using the primary rendering thread, rendering data stored in a backward buffer in the primary rendering thread to a bridge buffer, a shared texture identifier being bound to the bridge buffer; obtaining, by using the secondary rendering thread, the rendering data from the bridge buffer based on the shared texture identifier; drawing the rendering data onto an input rendering surface provided by the encoding thread, to obtain an output rendering surface, and transmitting the output rendering surface to the encoding thread; and encoding, by using the encoding thread, the output rendering surface, to obtain recorded video frame data. In the foregoing screen recording method, a corresponding recording application process is allocated to an application in advance to record a displayed image of the application. In this way, recording of the displayed image of the application is implemented by using the primary rendering thread, the secondary rendering thread, and the encoding thread in the recording application process, which does not involve use of a screen rendering process in a system. Therefore, displayed content or notification content of another application program unrelated to the application is not recorded, thereby effectively satisfying an actual screen recording requirement of a user. In addition, as the foregoing screen recording method is implemented by using the recording application process corresponding to the application, rendering data can be directly obtained and used in the recording application process. In a case in which obtaining data in another application program is not involved, a system permission does not need to be applied for before screen recording, thereby simplifying an operation process of screen recording and improving implementation efficiency of a screen recording function.

### BRIEF DESCRIPTION OF THE DRAWINGS

FIG. 1 is a schematic diagram of a screen recording method according to related technology.

FIG. 2 is a specific flowchart of obtaining video frame data by using a system API according to related technology.

FIG. 3 is a schematic diagram of an application scenario of a screen recording method according to an aspect of this disclosure.

FIG. 4 is a schematic diagram of a rendering logic applied on a terminal device according to an aspect of this disclosure.

FIG. 5 is a method flowchart of a screen recording method according to an aspect of this disclosure.

FIG. 6 is a schematic diagram of interaction between threads of a recording application process according to an aspect of this disclosure.

FIG. 7 is a schematic diagram of a structure of a screen recording apparatus according to an aspect of this disclosure.

FIG. 8 is a schematic diagram of a structure of a terminal device according to an aspect of this disclosure.

FIG. 9 is a schematic diagram of a structure of a server according to an aspect of this disclosure.

### DETAILED DESCRIPTION

To better understand the solutions of this disclosure, the following describes the technical solutions of the aspects of this disclosure with reference to the accompanying drawings. The described aspects are merely some rather than all of the aspects of this disclosure. Other aspects shall fall within the scope of this disclosure. Further, the descriptions of the terms are provided as examples only and are not intended to limit the scope of the disclosure.

In the specification, claims, and accompanying drawings of this disclosure, the terms “first”, “second”, “third”, “fourth” and the like (if present) are configured for distinguishing similar objects but do not necessarily indicate a specific order or sequence. Data used in this way may be interchanged in a proper circumstance, so that the aspects of this disclosure described herein can be implemented in a sequence different from those shown in the drawings or described herein. In addition, the terms “include” and “have” and any variants thereof are intended to cover non-exclusive inclusion, for example, a process, method, system, product, or device that includes a series of operations or units is not necessarily limited to those listed operations or units, but may include another operation or unit that is not listed or is inherent to the process, method, product, or device.

In related technology, when an application program, such as a game application program or a conference application program, having a screen recording requirement on a terminal device is performing screen recording, a screen rendering process in a system is called to record displayed content.

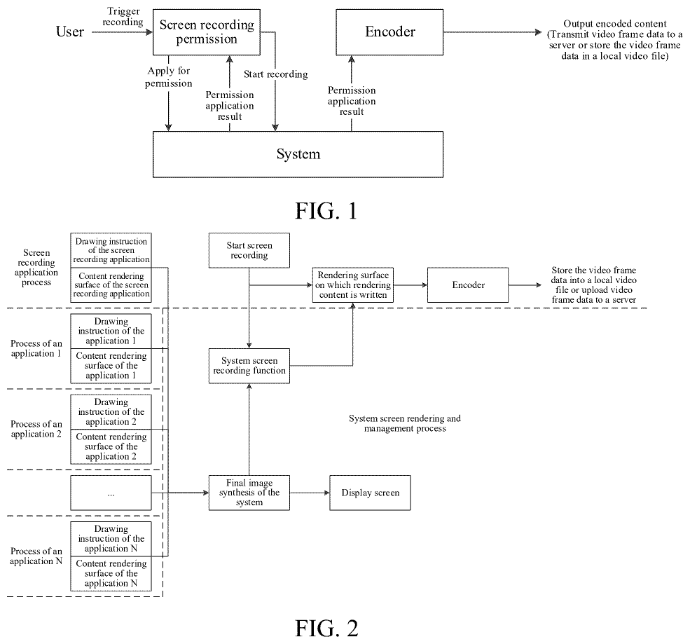

FIG. 1 is a schematic diagram of the screen recording method in the foregoing related technology. When a user triggers a screen recording process by using a screen recording application (which may be any application program having a screen recording function) in a terminal device, the terminal device records all content displayed on a screen, which involves content displayed in a plurality of application programs in the terminal device. Therefore, before starting screen recording, the screen recording application needs to apply for a screen recording permission from a system. Only after the screen recording application receives a permission application result that the system agrees to perform screen recording, can the screen recording application call an application programming interface (API) of the system and start recording the content displayed on the screen of the terminal device. After starting screen recording, the screen recording application obtains, by using the system API, video frames obtained through recording, transmits the video frames to an encoder, encodes the video frames by using the encoder, obtains video frame data obtained through the screen recording, and transmits the video frame data to a server or stores the video frame data into a local video file of the terminal device based on an actual scenario requirement.

For a specific process of obtaining the video frame data by using the system API, refer to FIG. 2. In FIG. 2, a screen recording application process is used as a recording demand side. After a screen recording permission application is applied for, screen recording is initiated by using a screen recording API provided by the system, and an encoder is created. The encoder provides a rendering surface for carrying screen recording content, and the rendering surface is transmitted to a system screen rendering and management process by using the screen recording API. The system screen rendering and management process collects drawing instructions and content rendering surfaces in all application processes on a screen of a terminal device, synthesizes, based on rendering content corresponding to the drawing instructions and the content rendering surfaces in all application processes, an image that needs to be finally displayed, and displays the image on the screen of the terminal device. After screen recording is started, the system screen rendering and management process writes collected rendering content into the rendering surface provided by the encoder, and transmits the rendering surface on which the rendering content is written back to the encoder in the screen recording application. The rendering surface on which the rendering content is written is encoded by using the encoder, and the video frame data to be obtained for the screen recording is finally generated. The video frame data is written into a local video file or is pushed to a server based on an actual recording requirement.

It can be seen that, in the screen recording method described in the related technology, during the screen recording, each video frame image is obtained through the screen rendering process in the system, that is, the system screen rendering and management process. By calling the screen rendering process in the system to record displayed content, all displayed content on the screen is recorded. In this way, recorded content not only includes displayed content of an application program required by a user and that has a screen recording requirement (that is, a screen recording application), but also includes displayed content or notification content of another application program on a terminal device that is not required by the user, and does not satisfy an actual screen recording requirement of the user, causing unnecessary waste of data processing resources. In addition, as all the displayed content on the screen is recorded, displayed content of another application program is obtained. Therefore, the application program having the screen recording requirement further needs to apply for a system permission before the screen recording, and the screen recording is performed after the application program is authorized, causing complicated operations.

In addition, when the screen rendering process in the system is called to record the displayed content, cross-process data interaction needs to be performed. In other words, a rendering surface is exchanged between the screen recording application process and the screen rendering process in the system. When cross-process transmission of a large quantity of video frames needs to be performed, a performance problem may appear.

To resolve the foregoing problem, the aspects of this disclosure provide a screen recording method. The screen recording method is applied to a recording application process corresponding to an application including a primary rendering thread, a secondary rendering thread, and an encoding thread. The secondary rendering thread and the encoding thread are enabled in response to a screen recording operation triggered by using the application. The screen recording method includes: replicating, by using the primary rendering thread, rendering data stored in a backward buffer in the primary rendering thread to a bridge buffer, a shared texture identifier being bound to the bridge buffer; obtaining, by using the secondary rendering thread, the rendering data from the bridge buffer based on the shared texture identifier; drawing the rendering data onto an input rendering surface provided by the encoding thread, to obtain an output rendering surface, and transmitting the output rendering surface to the encoding thread; and encoding, by using the encoding thread, the output rendering surface, to obtain recorded video frame data.

In the foregoing screen recording method, recording of the displayed image of the application is implemented by using the primary rendering thread, the secondary rendering thread, and the encoding thread in the recording application process, which does not involve use of a screen rendering process in a system. Therefore, displayed content or notification content of another application program unrelated to the application is not recorded, thereby effectively satisfying an actual screen recording requirement of a user. In addition, as the foregoing screen recording method is implemented by using the recording application process corresponding to the application, rendering data can be directly obtained and used in the recording application process. In a case in which obtaining data in another application program is not involved, a system permission does not need to be applied for before screen recording, thereby simplifying an operation process of screen recording and improving implementation efficiency of a screen recording function.

In addition, in the screen recording method provided in the aspects of this disclosure, data exchange is performed only in the recording application process, that is, data transmission is performed among the primary rendering thread, the secondary rendering thread, and the encoding thread in the recording application process. Compared with cross-process data transmission between a system and a screen recording application in the related technology, the screen recording method provided in the aspects of this disclosure avoids the related performance problem.

The screen recording method provided in the aspects of this disclosure may be implemented by using a computer device, and the computer device may be a terminal device. The terminal device includes, but is not limited to, a mobile phone, a computer, an intelligent speech interaction device, an intelligent appliance, an on board terminal, and the like. The terminal device may be directly or indirectly connected to a server in a wired or wireless communication manner. This is not limited in this disclosure.

For ease of understanding the screen recording method provided in the aspects of this disclosure, an application scenario of the screen recording method is described below by using an example in which the screen recording method is performed by the terminal device.

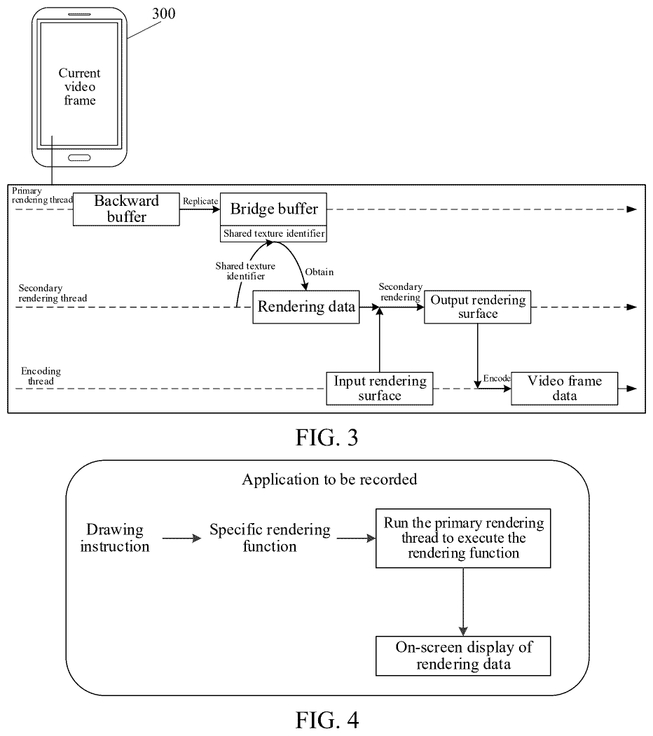

FIG. 3 is a schematic diagram of an application scenario of a screen recording method according to an aspect of this disclosure. In the application scenario shown in FIG. 3, a terminal device 300 is used as an instance of the foregoing computer device for executing the screen recording method provided in the aspects of this disclosure for description.

In FIG. 3, in the aspects of this disclosure, the application involved may be any application program having a screen recording function, and may be a game application, or may be an application of another type. After a screen recording process is triggered in the application, displayed content of the application on a screen of the terminal device 300 needs to be obtained, and screen recording of the application is implemented by saving the displayed content in real time.

If displayed content on the screen when the application runs needs to be recorded, a process specially responsible for screen recording is started, and the process may be referred to as a recording application process. The recording application process captures images and sound (if audio recording is set) on the screen and encodes the images and sound into video frame data. In a possible implementation, an operating system and various applications may implement a security measure and permission management. Therefore, in the aspects of this disclosure, an independent recording application process may be allocated to each application, to ensure that each recording application process is subject to proper permission and access control, thereby protecting security of user data, and also avoiding recording displayed content or notification content of an unrelated application. In other words, a correspondence between each application and a recording application process is set, so that in a screen recording process of each application, a recording application process corresponding to the application can be selected based on the correspondence, to execute the screen recording process of the application.

The recording application process of the application may include a primary rendering thread, a secondary rendering thread, and an encoding thread. The primary rendering thread, the secondary rendering thread, and the encoding thread jointly complete a screen recording function of the recording application process. Data transmission between the threads in the recording application process is performed in the recording application process. The recording application process may be a process configured for screen recording in the application. In a state in which screen recording is not performed, a rendering logic applied on the terminal device 300 is shown in FIG. 4. The primary rendering thread is configured to render content that needs to be displayed in the application on the screen of the terminal device 300 for the user to watch. When the primary rendering thread performs the rendering operation, a drawing engine or another image rendering framework generates a drawing instruction based on model data (for example, a model such as a person, a vehicle, or a building) and texture data in the application, and generates a specific rendering function based on the drawing instruction. The primary rendering thread executes the rendering function to render the model data and the texture data into an image, and finally implements on-screen display of rendering data.

After the screen recording is started, a video frame being displayed on the screen of the terminal device 300 is a current video frame. Rendering data corresponding to a next video frame after the current video frame is stored in a backward buffer of the primary rendering thread. As video frames are played on the screen of the terminal device 300, the displayed content in the application can be obtained in real time by obtaining the rendering data in the backward buffer. Therefore, after detecting that the screen recording is started, the primary rendering thread creates a shared texture identifier configured for sharing the rendering data and a bridge buffer configured for storing the rendering data, and binds the shared texture identifier with the bridge buffer. The rendering data in the backward buffer is replicated to the bridge buffer by the primary rendering thread. After obtaining the shared texture identifier, the secondary rendering thread can obtain, based on the shared texture identifier, the rendering data in the bridge buffer bound to the shared texture identifier, that is, the secondary rendering thread can obtain the rendering data in the backward buffer. In addition, as content corresponding to the shared texture identifier is the rendering data in the bridge buffer, when the rendering data is replicated from the backward buffer to the bridge buffer, the content corresponding to the shared texture identifier is also updated. In this way, the secondary rendering thread obtains the rendering data in the backward buffer in real time, and the screen recording is implemented by using the rendering data obtained in real time.

During the recording application process, the encoding thread is configured to encode a video image obtained by the secondary rendering thread, to obtain video frame data recorded in the screen recording. During the screen recording, the encoding thread creates an input rendering surface, and provides the input rendering surface for the secondary rendering thread, to carry rendering content generated by the secondary rendering thread. In the secondary rendering thread, after the rendering data is obtained, the rendering data is drawn onto the input rendering surface provided by the encoding thread. After the drawing is completed, an output rendering surface corresponding to the input rendering surface is obtained, and the output rendering surface is a video frame displayed on the screen of the terminal device 300 during the screen recording. In addition, as the video frame is generated based on the rendering data in the application, the video frame only includes displayed content in the application, satisfying the screen recording requirement of the user in the application. The output rendering surface drawn in the secondary rendering thread is transmitted to the encoding thread. After receiving the output rendering surface, the encoding thread encodes the output rendering surface. Each encoded output rendering surface forms video frame data in the screen recording process. In the video frame data, video frames are arranged based on a time sequence. The video frame data is stored frame by frame to generate a video of the screen recording.

In other words, when the screen recording is performed in the application, the rendering data can be obtained and used in the application by the recording application process, thereby avoiding cross-process transmission of a video frame. The primary rendering thread obtains the rendering data of the backward buffer and replicates the rendering data to the bridge buffer, so that the secondary rendering thread can obtain, based on the shared texture identifier created by the primary rendering thread, the rendering data in the bridge buffer bound to the shared texture identifier, draw the rendering data onto the input rendering surface provided by the encoding thread, transmit the output rendering surface obtained after the drawing is completed to the encoding thread for encoding, and finally obtain the video frame data recorded in the screen recording. Only a simple rendering data replication operation is performed in the primary rendering thread, and secondary rendering on the rendering data in the application is performed by the secondary rendering thread. In this way, an impact of the screen recording on the primary rendering thread is reduced. In addition, recording of a displayed image of the application is implemented by the recording application process, in which rendering content and data in another application program are not involved, and system permission does not need to be applied for before the screen recording, thereby simplifying an operation process of the screen recording, and effectively satisfying the screen recording requirement of the user in the application.

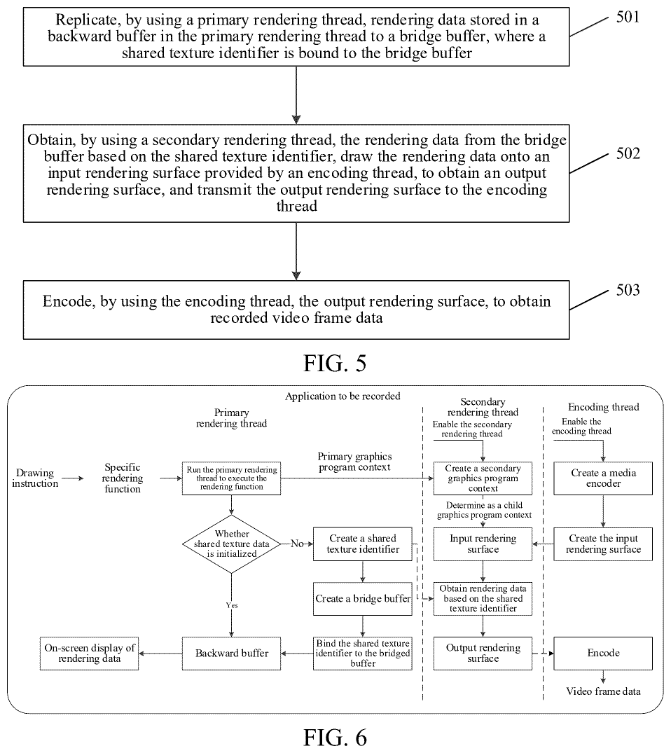

FIG. 5 is a method flowchart of a screen recording method according to an aspect of this disclosure. The method may be performed by a terminal device as the foregoing computer device. The method is applied to a recording application process corresponding to an application. The recording application process includes a primary rendering thread, a secondary rendering thread, and an encoding thread, and the secondary rendering thread and the encoding thread are enabled in response to a screen recording operation triggered by using the application. As shown in FIG. 5, the method includes the following operations:

Operation 501: Replicate, by using the primary rendering thread, rendering data stored in a backward buffer in the primary rendering thread to a bridge buffer, where a shared texture identifier is bound to the bridge buffer. For example, through the primary rendering thread, rendering data stored in a back buffer of the primary rendering thread is copied to a bridge buffer. A shared texture identifier is bound to the bridge buffer.

Rendering may refer to a process in which software of various electronic devices such as a computer end, a mobile end, and a game console generates an image from a model. The model is a description of a three-dimensional object or a virtual scenario strictly defined by using a language or a data structure, and includes information such as a geometry, a viewpoint, a texture, illumination, and a shadow. The texture is a two-dimensional image that is usually mapped on a surface of a three-dimensional model, so that the surface of the model is more real and detailed. This disclosure does not limit a type of a terminal device for performing the screen recording method, and the terminal device may be a mobile phone, a computer, or the like.

In the aspects of this disclosure, a process of generating a specific scenario image based on abstract model data and texture data is rendering, for example, a process of generating different displayed images corresponding to controls in a game application based on running parameters, such as a change manner, a change angle, and a change speed, of the controls stored in the game application. In the terminal device, the primary rendering thread may use an open graphics library (OpenGL). The OpenGL is a cross-language and cross-platform application programming interface configured for rendering a two-dimensional or three-dimensional vector graphic, and is widely applied to various image rendering scenarios, including but not limited to game rendering, computer-aided design drawing, and the like, to render various graphic rendering scenarios in terminal device applications.

The backward buffer and the bridge buffer are both frame buffers. A frame buffer may be used as a memory buffer, and is configured to store pixel data of a rendering result, including information such as a color, a depth, and a template.

The primary rendering thread is a thread that renders displayed content in the application during running of the application, and is configured to render the displayed content in the application to obtain rendering data. The rendering data obtained is stored in the backward buffer of the primary rendering thread. The rendering data is a type of pixel data, and a displayed image applied on the screen of the terminal device may be obtained by drawing the pixel data. This disclosure does not limit a type of the application. For example, the application may be a game application, a conference application, a live streaming application, or the like.

The bridge buffer is a buffer that is created by the primary rendering thread to share the rendering data. In the aspects of this disclosure, the rendering data generated by the primary rendering thread, in addition to being stored in the backward buffer, is further replicated to the bridge buffer for storage. In the aspects of this disclosure, the primary rendering thread may replicate the rendering data stored in the backward buffer to the bridge buffer. As the shared texture identifier is bound to the bridge buffer, the shared texture identifier is a unique identifier configured to identify a texture object, and may be configured to refer to the texture object during rendering. Whether the bridge buffer is bound to the shared texture identifier indicates whether the texture object (for example, the rendering data in the aspects of this disclosure) in the bridge buffer can be referred to. Therefore, when the shared texture identifier is bound to the bridge buffer, the shared texture identifier can be configured to refer to the texture object in the bridge buffer, to obtain the rendering data replicated from the backward buffer by the bridge buffer. The shared texture identifier may be various types of identifiers, such as a symbol, a number, and a letter.

When the application runs normally, the primary rendering thread is mainly configured to render the displayed content in the application, to generate the displayed image. In the aspects of this disclosure, when screen recording is performed, a rendering data replication operation is performed only in the primary rendering thread, and the replication operation of the rendering data that is performed by the primary rendering thread from the backward buffer to the bridge buffer is run in a cache of a graphics processing unit (GPU). In this case, a processing data volume is small, an execution speed is high, and an impact on a frame rate and rendering efficiency when the primary rendering thread runs normally is reduced.

In a possible implementation, the screen recording method of this disclosure may further include the following operations:
creating, by using the secondary rendering thread, based on a primary graphics program context corresponding to the primary rendering thread, a secondary graphics program context corresponding to the secondary rendering thread, and determining the primary graphics program context as a parent graphics program context of the secondary graphics program context.

The shared texture identifier created in the primary rendering thread corresponding to the parent graphics program context supports being used by the secondary rendering thread corresponding to the secondary graphics program context.

In an OpenGL application programming interface, a graphics program context (OpenGL context) represents a current status and environment of the OpenGL, and includes all OpenGL status information, such as a current rendering mode, a buffer object, a texture object, and a shader program. In the OpenGL, all rendering operations are performed in a current OpenGL context.

In the aspects of this disclosure, when the primary rendering thread is running, a corresponding primary graphics program context includes a program running status record, running data, and the like of the primary rendering thread. The primary rendering thread provides the primary graphics program context thereof to the secondary rendering thread, and the secondary rendering thread may create a secondary graphics program context corresponding to the secondary rendering thread based on the primary graphics program context. The secondary graphics program context includes a program running record, running data, and the like of the secondary rendering thread.

In a process of creating the secondary graphics program context based on the primary graphics program context, the secondary rendering thread may further specify a parent graphics program context corresponding to the secondary graphics program context. After the parent graphics program context is specified, a shared texture identifier in a thread corresponding to the parent graphics program context may be provided to a thread corresponding to a child graphics program context for use. In the aspects of this disclosure, the primary graphics program context corresponding to the primary rendering thread is determined as the parent graphics program context of the secondary graphics program context, and then the secondary graphics program context is the child graphics program context of the primary graphics program context. In this way, the shared texture identifier created in the primary rendering thread corresponding to the parent graphics program context can be used by the secondary rendering thread corresponding to the child graphics program context, forming a basis for sharing the rendering data between the primary rendering thread and the secondary rendering thread. Therefore, the secondary rendering thread can access, based on the shared texture identifier, the bridge buffer bound to the shared texture identifier, and obtain the rendering data from the bridge buffer.

The secondary graphics program context corresponding to the secondary rendering thread is created by using the primary graphics program context, and the primary graphics program context is determined as the parent graphics program context of the secondary graphics program context, so that the secondary rendering thread uses the shared texture identifier in the primary rendering thread. In this way, sharing of the rendering data between the primary rendering thread and the secondary rendering thread is implemented, thereby improving efficiency of obtaining the rendering data by the secondary rendering thread.

In a possible implementation, the screen recording method of this disclosure may further include the following operations (not shown in the accompanying figure):
Operation 11: Create, by using the primary rendering thread, if it is detected by using the primary rendering thread that shared texture data is not initialized, the shared texture identifier and the bridge buffer; bind the shared texture identifier to the bridge buffer; and replicate, by using the primary rendering thread, the rendering data stored in the backward buffer in the primary rendering thread to the bridge buffer.

In the primary rendering thread, whether the shared texture data is initialized can be detected by using the primary rendering thread. In a possible implementation, whether the shared texture data in the primary rendering thread is initialized may be determined by detecting whether the shared texture identifier and the bridge buffer bound to the shared texture identifier exist. When the shared texture identifier and the bridge buffer bound to the shared texture identifier already exist in the primary rendering thread, it is considered that the shared texture data in the primary rendering thread has been initialized; otherwise, it is considered that the shared texture data in the primary rendering thread has not been initialized.

In the aspects of this disclosure, an objective of detecting whether the shared texture data is initialized is to determine whether there is a corresponding buffer to store replicated rendering data after the replication operation is performed on the rendering data in the backward buffer of the primary rendering thread. If yes, the replication operation can be directly performed on the data in the backward buffer; if not, a corresponding shared texture identifier and a corresponding bridge buffer need to be created, to store the rendering data replicated from the backward buffer.

If it is detected by using the primary rendering thread that the shared texture data is not initialized, create, by using the primary rendering thread, the shared texture identifier and the bridge buffer; bind the shared texture identifier to the bridge buffer; and replicate, by using the primary rendering thread, the rendering data stored in the backward buffer in the primary rendering thread to the bridge buffer.

When the shared texture data in the primary rendering thread is not initialized, the primary rendering thread needs to create the shared texture identifier and the bridge buffer, and bind the two. The bridge buffer is configured to store the rendering data replicated from the backward buffer. Based on the foregoing replication operation on the rendering data and the binding relationship between the bridge buffer and the shared texture identifier, the shared texture identifier is configured to map the rendering data in the bridge buffer. Based on such mapping, the secondary rendering thread can obtain, by using the shared texture identifier, same rendering data as that in the backward buffer of the primary rendering thread. In addition, when new rendering data is replicated, and the rendering data in the bridge buffer is updated, the mapping between the shared texture identifier and the rendering data is also updated accordingly.

Binding the shared texture identifier and the bridge buffer may refer to associating the shared texture identifier with the bridge buffer, to efficiently share and transmit rendering data in a rendering process. By means of this binding relationship, the texture data (that is, the rendering data) associated with the shared texture identifier can be directly read from the bridge buffer without reloading or replicating data. In this way, data transmission overheads can be greatly reduced, and rendering efficiency and performance can be improved.

Operation 12: Replicate, if it is detected by using the primary rendering thread that the shared texture data is initialized, by using the primary rendering thread, the rendering data stored in the backward buffer in the primary rendering thread to the bridge buffer.

When the shared texture data in the primary rendering thread has been initialized, then based on the shared texture identifier created by the primary rendering thread when the shared texture data is initialized and the bridge buffer bound to the shared texture identifier, the replication operation is performed on the rendering data stored in the backward buffer of the primary rendering thread, and the foregoing rendering data is replicated from the backward buffer to the bridge buffer. As the bridge buffer is bound to the shared texture identifier, the rendering data in the bridge buffer can be shared based on the shared texture identifier, thereby implementing sharing of the rendering data in the backward buffer of the primary rendering thread.

The primary rendering thread initializes the shared texture data, creates the shared texture identifier and the bridge buffer bound to the shared texture identifier, stores the rendering data replicated from the backward buffer in the bridge buffer, and shares the rendering data based on the shared texture identifier bound to the bridge buffer. The texture data (that is, the rendering data) associated with the shared texture identifier can be directly read from the bridge buffer without reloading or replicating data. In this way, data transmission overheads can be greatly reduced, and rendering efficiency and performance can be improved.

In a possible implementation, operation 501 is implemented in the following method (not shown in the accompanying figure):
Operation 21: Set, by using the primary rendering thread, the bridge buffer as a current write buffer in the primary rendering thread, and the backward buffer as a current read buffer in the primary rendering thread.

During running of the primary rendering thread, the current read buffer currently configured to read data and the current write buffer currently configured to write data are set, and data read from the current read buffer is written into the current write buffer.

In the aspects of this disclosure, when the rendering data in the backward buffer of the primary rendering thread needs to be replicated, the backward buffer is set as the current read buffer, so that the rendering data stored in the current read buffer is read from the current read buffer. Meanwhile, the bridge buffer is used as the current write buffer of the primary rendering thread, to write the foregoing rendering data.

Operation 22: Replicate, by using the primary rendering thread, the rendering data from the current read buffer to the current write buffer by executing a buffer replication function.

The buffer replication function is a function, for example, a glBlitFramebuffer function in an OpenGL, that can replicate content of one buffer to another buffer. The buffer replication function is used when rendering data of a backward buffer is replicated. The buffer replication function is executed by using the primary rendering thread. The function replicates the rendering data in the current read buffer to the current write buffer, that is, replicates the rendering data in the backward buffer to the bridge buffer.

The current write buffer and the current read buffer are set in the primary rendering thread, and the buffer replication function is executed, so that sharing of the rendering data between the backward buffer and the bridge buffer is implemented.

In a possible implementation, operation 22 is implemented in the following method:
replicating, by using the primary rendering thread, color data stored in a color buffer in the current read buffer to the current write buffer by executing the buffer replication function.

In the primary rendering thread, the rendering data stored in the current read buffer is a type of pixel data. The pixel data includes information such as a color, a depth, and a template. A buffer storing the color is the color buffer, and a buffer in which the pixel data is read from an OpenGL is usually the color buffer. The pixel data is a pixel value corresponding to each pixel on a display screen of a terminal device, and a color of a corresponding pixel point may be determined by using the pixel value. When the rendering data is read from the current read buffer, the rendering data may be set to be read from the color buffer of the current read buffer. The color data stored in the color buffer is read and replicated to the current write buffer, so that sharing of the color data between the backward buffer and the bridge buffer is implemented.

The color data is content directly presented to a user on a screen, and a final objective of screen recording is to capture displayed content on the screen. Therefore, the color data is the most direct and key information. In the aspects of this disclosure, the color data is replicated to the current write buffer, so that the color data can be directly read from the current write buffer for data sharing, thereby quickly rendering the most direct and key information of the displayed content on the screen, and better implementing the screen recording.

In an aspect, based on operation 21 and operation 22, after screen recording ends, the method may further include the following operations:
in response to a screen recording stop operation triggered by using the application, performing, by using the primary rendering thread, recovery processing on a read frame buffer target and a write frame buffer target in the primary rendering thread. The recovery processing is configured to recover the read frame buffer target and the write frame buffer target to values before responding to the screen recording operation.

The read frame buffer target is configured to indicate the current read buffer, and the write frame buffer target is configured to indicate the current write buffer.

During the screen recording, in the primary rendering thread, a current read buffer to which the read frame buffer target points is the backward buffer, and a current write buffer to which the write frame buffer target points is a bridge buffer. This setting is a specific setting in the screen recording scenario. After the screen recording ends, this specific setting may affect normal working of the primary rendering thread. Therefore, in response to the screen recording stop operation triggered by the application, the screen recording ends. The recovery processing needs to be performed on the read frame buffer target and the write frame buffer target in the primary rendering thread by using the primary rendering thread, to recover the read frame buffer target and the write frame buffer target in the primary rendering thread to the values before the screen recording starts. In this way, the primary rendering thread can be recovered to a working status before the screen recording starts and continue to execute a rendering task before the screen recording starts.

After the screen recording stops, the read frame buffer target and the write frame buffer target in the primary rendering thread are recovered to the values before responding to the screen recording operation, reducing an impact of the screen recording on the primary rendering thread in the application.

Operation 502: Obtain, by using the secondary rendering thread, the rendering data from the bridge buffer based on the shared texture identifier; draw the rendering data onto an input rendering surface provided by the encoding thread, to obtain an output rendering surface; and transmit the output rendering surface to the encoding thread. For example, through the secondary rendering thread, the rendering data from the bridge buffer is obtained based on the shared texture identifier. The rendering data is drawn onto an input rendering surface provided by the encoding thread to generate an output rendering surface.

The secondary rendering thread may be a thread that runs independently of the primary rendering thread in the recording application process, and is configured to perform secondary rendering on the rendering data obtained by using the primary rendering thread, to recover rendering content drawn by the primary rendering thread based on the rendering data, and perform screen recording based on the rendering content.

In the aspects of this disclosure, the secondary rendering thread may access, based on the shared texture identifier, the bridge buffer bound to the shared texture identifier, to refer to a corresponding texture object from the bridge buffer. In other words, the rendering data replicated from the backward buffer may be obtained from the bridge buffer based on the shared texture identifier. Sharing of the rendering data in the backward buffer is implemented by using the shared texture identifier and the bridge buffer, so that the secondary rendering thread can draw rendering content consistent with that of the primary rendering thread. In the aspects of this disclosure, pixel values corresponding to pixel points in the displayed image are recorded in pixel data collected by using the rendering data through the primary rendering thread, and the rendering content is specific content drawn based on the rendering data.

After the rendering data is obtained, the secondary rendering thread needs to perform secondary rendering on the rendering data in the application, and draw the rendering content obtained through the secondary rendering onto the input rendering surface provided by the encoding thread. The input rendering surface is a blank surface created by the encoding thread and configured to carry the rendering content. During drawing, the rendering data may be drawn onto the input rendering surface by using a drawing command. In the aspects of this disclosure, the input rendering surface may be an abstract interface configured to display an image, and drawing the rendering data onto the input rendering surface may be writing the rendering data into a memory buffer of the input rendering surface for subsequent display or processing. After completing drawing the input rendering surface, the secondary rendering thread obtains the corresponding output rendering surface. The output rendering surface is a video frame obtained through the screen recording. The secondary rendering thread further transmits the output rendering surface to the encoding thread, and performs subsequent processing on the output rendering surface in the encoding thread.

In a possible implementation, the secondary rendering thread draws the input rendering surface (not shown in the accompanying figure) through the following operations:
Operation 31: Build a shader by using the secondary rendering thread.
Operation 32: Draw, by using the shader, a rendering result based on a mapping relationship between a vertex coordinate of the input rendering surface and a texture coordinate of the rendering data.
Operation 33: Output the rendering result to the input rendering surface, to obtain the output rendering surface.

The shader is a drawing tool for drawing a graph based on the rendering data. When the shader is created in the secondary rendering thread, a vertex shader and a fragment shader may be created by using a rendering function in an OpenGL. The vertex shader is configured to draw an output vertex, and the fragment shader is configured to draw an output color. The vertex shader and the fragment shader are linked, so that a program object corresponding to the shader can be obtained.

After obtaining the rendering data and the input rendering surface, the secondary rendering thread needs to correspond the texture coordinate of the rendering data to the vertex coordinate of the input rendering surface, to draw content corresponding to the rendering data onto the input rendering surface, and recover the rendering content drawn by the primary rendering thread based on the rendering data.

When rendering is performed by using the shader, the rendering result corresponding to the rendering data is drawn based on the mapping relationship between the vertex coordinate of the input rendering surface and the texture coordinate of the rendering data. For example, in a rendering process, the input rendering surface may be divided into two parts based on a diagonal line of a rectangle corresponding to the input rendering surface, and each part is a triangle. Triangles of the two parts are drawn based on the foregoing mapping relationship, to complete drawing of the input rendering surface.

The rendering result obtained based on the rendering data is drawn onto the input rendering surface provided by the encoding thread. For example, the rendering result may be drawn onto the input rendering surface by using a swapbuffer function in the OpenGL. In the secondary rendering thread, the input rendering surface is an output object of the rendering result of the secondary rendering thread.

In the aspects of this disclosure, the shader is configured to perform secondary rendering, so that a more realistic and vivid image can be generated. In addition, the shader runs on a GPU, so that a parallel processing capability of the GPU can be fully used. The secondary rendering performed by using the shader can greatly increase a rendering speed and improve rendering efficiency.

Operation 503: Encode, by using the encoding thread, the output rendering surface, to obtain recorded video frame data. For example, through the encoding thread, the output rendering surface is encoded to generate video frame data.

The encoding thread is a thread configured to encode the output rendering surface to obtain the recorded video frame data. After processing of the primary rendering thread and the secondary rendering thread, output rendering surfaces corresponding to frames of a displayed image in the application during the screen recording are outputted to the encoding thread for encoding. An encoding process is a processing process of encoding and sorting output rendering surfaces to obtain a video frame sequence. After obtaining the output rendering surfaces, the encoding thread encodes video frame images corresponding to the output rendering surfaces based on a preset sequence, to generate the video frame data. The preset sequence may be a time sequence corresponding to recording. The video frame data may be a video frame combination sequence arranged based on the preset sequence. When the video frame combination sequence is played, all video frames displayed in the application during the screen recording can be viewed, and therefore, a video corresponding to the current screen recording can be obtained.

In the aspects of this disclosure, the video frame data finally generated by using the encoding thread may be written into a local video file of the terminal device for viewing, or uploaded to a server for backup, satisfying different screen recording requirements of a user for the application.

In the aspects of this disclosure, the video frame data may be outputted in a plurality of different forms. This is not limited in this disclosure.

In a possible implementation, the encoding thread encodes the output rendering surface through the following operations (not shown in the accompanying figure):
Operation 41: Create, by using the encoding thread, a media encoder; and
Operation 42: Create, by using the media encoder, an input rendering surface, and transmit the input rendering surface to the secondary rendering thread.

In this case, operation 503 may be implemented in the following method:
performing, by using the media encoder, encoding based on the output rendering surface, to obtain the video frame data.

In the OpenGL, the media encoder is configured to encode original video frame image data according to an international standard, so that the data can be efficiently transmitted and stored on the Internet. In the aspects of this disclosure, the media encoder is configured to encode the output rendering surface outputted by the secondary rendering thread.

When the media encoder is created by using the encoding thread, the media encoder is provided by a system platform of the terminal device, and the media encoder may be created by calling a system universal API. This disclosure does not limit a type of the system platform of the terminal device.

After the media encoder is created, the media encoder may create a blank input rendering surface, and transmit the blank input rendering surface to the secondary rendering thread. After the input rendering surface is processed by the secondary rendering thread, the input rendering surface may be used as input data of the media encoder in the encoding thread.

A data input source of the media encoder is the secondary rendering thread, and corresponding input data is the output rendering surfaces drawn by the secondary rendering thread based on the rendering data. The media encoder encodes these output rendering surfaces, and arranges the output rendering surfaces based on the preset sequence, to obtain recorded video frame data of the screen recording this time. The video frame data may be transmitted to a server or stored in a local video file of the terminal device based on a user requirement. The video frame data includes all displayed images of the application on the screen of the terminal device in the current screen recording process.

The encoding thread creates the media encoder and creates the input rendering surface by using the media encoder, bringing benefits such as hardware acceleration, efficient resource management, flexibility and scalability, delay reduction, and video quality improvement. These benefits endow the media encoder a wide application prospect in fields such as video processing, real-time rendering, and streaming media transmission.

The aspects of this disclosure provide a screen recording method. The screen recording method is applied to a recording application process corresponding to an application, and the recording application process includes a primary rendering thread, a secondary rendering thread, and an encoding thread. The secondary rendering thread and the encoding thread are enabled in response to a screen recording operation triggered by using the application. The screen recording method includes: replicating, by using the primary rendering thread, rendering data stored in a backward buffer in the primary rendering thread to a bridge buffer, a shared texture identifier being bound to the bridge buffer; obtaining, by using the secondary rendering thread, the rendering data from the bridge buffer based on the shared texture identifier; drawing the rendering data onto an input rendering surface provided by the encoding thread, to obtain an output rendering surface, and transmitting the output rendering surface to the encoding thread; and encoding, by using the encoding thread, the output rendering surface, to obtain recorded video frame data. In the foregoing screen recording method, recording of the displayed image of the application is implemented by using the primary rendering thread, the secondary rendering thread, and the encoding thread in the recording application process, which does not involve use of a screen rendering process in a system. Therefore, displayed content or notification content of another application program unrelated to the application is not recorded, thereby effectively satisfying an actual screen recording requirement of a user. In addition, as the foregoing screen recording method is implemented by using the recording application process corresponding to the application, rendering data can be directly obtained and used in the recording application process. In a case in which obtaining data in another application program is not involved, a system permission does not need to be applied for before screen recording, thereby simplifying an operation process of screen recording and improving implementation efficiency of a screen recording function.

Further, during the screen recording, a size of a video obtained during the screen recording may further be set based on an actual requirement of a user. For example, the size is implemented through the following operations (not shown in the accompanying figure):
Operation 51: Obtain a recorded video size set by the application, where the recorded video size is configured to indicate a video frame size obtained through the screen recording.
Operation 52: Create, by using the encoding thread, an input rendering surface corresponding to the recorded video size, and provide the input rendering surface for the secondary rendering thread, to obtain, by recording based on the input rendering surface, the video frame data corresponding to the recorded video size.

When the screen recording is performed in the application, the user can set the recorded video size. When a media encoder in the encoding thread creates an input rendering surface, the media encoder may create, based on the recorded video size set by the user, an input rendering surface conforming to the recorded video size. The secondary rendering thread draws rendering content on the input rendering surface, and an obtained output rendering surface also conforms to the recorded video size. In this case, finally, each video frame in the video frame data outputted by the encoding thread also conforms to the recorded video size. Therefore, by using the recorded video size, a size of an output video frame of the current screen recording is determined, satisfying different requirements of the user on a size of a video recorded on the screen.

Further, during the screen recording, a frame rate of the video obtained during the screen recording may further be set based on an actual requirement of the user. For example, the operation is implemented in the following method:
obtaining a recorded video frame rate set by using the application, and the recorded video frame rate is configured to indicate a video frame rate obtained through the screen recording.

In this case, the secondary rendering thread draws the input rendering surface through the following operation:
drawing, by using the secondary rendering thread, the input rendering surface based on the rendering data and a drawing periodicity corresponding to the recorded video frame rate, to obtain the output rendering surface.

During the screen recording, the recorded video frame rate can be set. When drawing the input rendering surface, the secondary rendering thread draws the input rendering surface based on the drawing periodicity corresponding to the recorded video frame rate. For example, when the recorded video frame rate is 30 frames per second, and a frame rate of the primary rendering thread of the application is 60 frames per second, then the secondary rendering thread draws the input rendering surface every other video frame. After the obtained output rendering surface is encoded by using the encoding thread, a frame rate corresponding to the video frame data conforms to the recorded video frame rate.

When the recorded video frame rate is higher than the frame rate of the primary rendering thread of the application, the secondary rendering thread may draw repeated frames when drawing the input rendering surface. For example, if the recorded video frame rate is 60 frames per second, and the frame rate of the primary rendering thread is 30 frames per second, then each video frame corresponding to the rendering data is drawn twice, and the video frame rate obtained through the screen recording is increased by adding repeated frames.

The recorded video frame rate is set to obtain screen recording video frame data corresponding to different frame rates, thereby effectively satisfying different requirements of the user on the video frame rate of the screen recording.

FIG. 6 is a schematic diagram of interaction between threads of a recording application process according to an aspect of this disclosure. The recording application process includes a primary rendering thread, a secondary rendering thread, and an encoding thread.

In the primary rendering thread, by receiving a drawing instruction, a specific rendering function corresponding to the drawing instruction is executed, to determine whether shared texture data is initialized. If yes, rendering data in a backward buffer is directly replicated to a bridge buffer bound to a shared texture identifier; and if not, the shared texture identifier and the bridge buffer are created, the shared texture identifier is bound to the bridge buffer, and then the rendering data in the backward buffer is replicated to the bridge buffer bound to the shared texture identifier. When the primary rendering thread runs normally, the rendering data in the buffer is rendered and then displayed on a screen for a user to watch.

In the secondary rendering thread, after the secondary rendering thread is enabled, a secondary graphics program context corresponding to the secondary rendering thread is created based on a primary graphics program context provided by the primary rendering thread. The primary graphics program context is determined as a parent graphics program context of the secondary graphics program context, and the secondary graphics program context is determined as a child graphics program context of the primary graphics program context. The secondary rendering thread obtains an input rendering surface created by the encoding thread, obtains the rendering data in the bridge buffer based on the shared texture identifier, performs secondary rendering based on the rendering data, draws a rendering result on the input rendering surface, obtains an output rendering surface after the drawing is completed, and provides the output rendering surface to the encoding thread for encoding.

After the encoding thread is enabled, a media encoder is first created, and then the media encoder creates the input rendering surface, and transmits the input rendering surface to the secondary rendering thread for drawing. After the drawing of the secondary rendering thread is completed, the encoding thread receives the output rendering surface carrying the rendering result from the secondary rendering thread, and encodes the output rendering surface, to obtain video frame data of this screen recording.

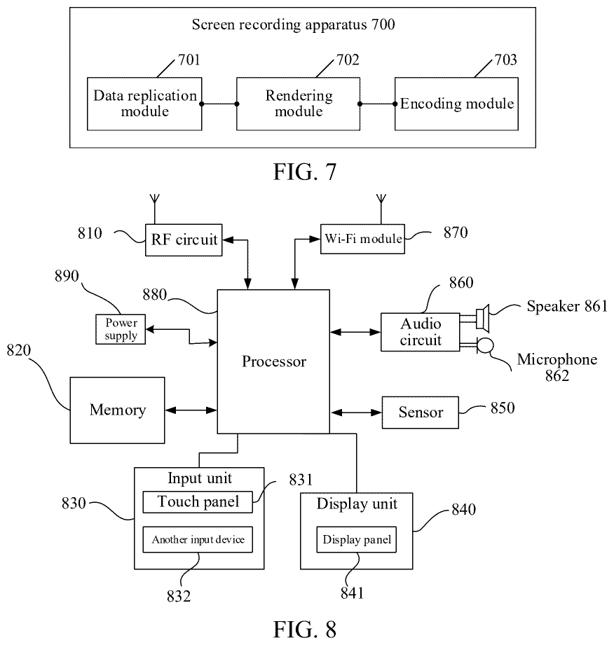

FIG. 7 is a schematic diagram of a structure of a screen recording apparatus 700 according to an aspect of this disclosure. The apparatus supports a recording application process corresponding to an application. The recording application process includes a primary rendering thread, a secondary rendering thread, and an encoding thread, and the secondary rendering thread and the encoding thread are enabled in response to a screen recording operation triggered by using the application. As shown in FIG. 7, the screen recording apparatus 700 includes:
a data replication module 701, configured to replicate, by using the primary rendering thread, rendering data stored in a backward buffer in the primary rendering thread to a bridge buffer, and a shared texture identifier is bound to the bridge buffer;
a rendering module 702, configured to: obtain, by using the secondary rendering thread, the rendering data from the bridge buffer based on the shared texture identifier, draw the rendering data onto an input rendering surface provided by the encoding thread, to obtain an output rendering surface, and transmit the output rendering surface to the encoding thread; and
an encoding module 703, configured to encode, by using the encoding thread, the output rendering surface, to obtain recorded video frame data.

In some aspects, the apparatus further includes a graphics program context creation module, which is configured to:
create, by using the secondary rendering thread, based on a primary graphics program context corresponding to the primary rendering thread, a secondary graphics program context corresponding to the secondary rendering thread, and determine the primary graphics program context as a parent graphics program context of the secondary graphics program context.

The shared texture identifier created in the primary rendering thread corresponding to the parent graphics program context supports being used by the secondary rendering thread corresponding to the secondary graphics program context.

In some aspects, the rendering module 702 is further configured to:
create, by using the primary rendering thread, if it is detected by using the primary rendering thread that shared texture data is not initialized, the shared texture identifier and the bridge buffer, and bind the shared texture identifier to the bridge buffer; and perform the replicate, by using the primary rendering thread, rendering data stored in a backward buffer in the primary rendering thread to a bridge buffer; and
performing, if it is detected by using the primary rendering thread that shared texture data is initialized, the replicating, by using the primary rendering thread, rendering data stored in a backward buffer in the primary rendering thread to a bridge buffer.

In some aspects, the data replication module 701 is configured to:
set, by using the primary rendering thread, the bridge buffer as a current write buffer in the primary rendering thread, and the backward buffer as a current read buffer in the primary rendering thread; and
replicate, by using the primary rendering thread, the rendering data from the current read buffer to the current write buffer by executing a buffer replication function.

In some aspects, the data replication module 701 is configured to:
replicate, by using the primary rendering thread, color data stored in a color buffer in the current read buffer to the current write buffer by executing the buffer replication function.

In some aspects, the apparatus further includes a parameter recovery module, which is configured to:
in response to a screen recording stop operation triggered by the application, perform, by using the primary rendering thread, recovery processing on a read frame buffer target and a write frame buffer target in the primary rendering thread, where the recovery processing is configured to recover the read frame buffer target and the write frame buffer target to values before responding to the screen recording operation.

The read frame buffer target is configured to indicate the current read buffer, and the write frame buffer target is configured to indicate the current write buffer.

In some aspects, the rendering module 702 is configured to:
build, by using the secondary rendering thread, a shader;
draw, by using the shader, the rendering result based on a mapping relationship between a vertex coordinate of the input rendering surface and a texture coordinate of the rendering data; and
output the rendering result to the input rendering surface, to obtain the output rendering surface.

In some aspects, the encoding module 703 is further configured to:
create, by using the encoding thread, a media encoder; and
create, by using the media encoder, the input rendering surface, and transmit the input rendering surface to the secondary rendering thread.

The encoding module 703 is configured to:
encode, by using the media encoder, the output rendering surface, to obtain the video frame data.

In some aspects, the apparatus further includes a size setting module, which is configured to:
obtain a recorded video size set by the application, and the recorded video size is configured to indicate a video frame size obtained through screen recording; and
create, by using the encoding thread, the input rendering surface corresponding to the recorded video size, and provide the input rendering surface for the secondary rendering thread, to obtain, by recording based on the input rendering surface, the video frame data corresponding to the recorded video size.

In some aspects, the apparatus further includes a frame rate setting module, which is configured to:
obtain a recorded video frame rate set by the application, where the recorded video frame rate is configured to indicate a video frame rate obtained through screen recording.

The rendering module 702 is configured to:
draw, by using the secondary rendering thread, the input rendering surface based on the rendering data and a drawing periodicity corresponding to the recorded video frame rate, to obtain the output rendering surface.

In the screen recording apparatus provided in the aspects of this disclosure, recording of a displayed image of the application is implemented by using the primary rendering thread, the secondary rendering thread, and the encoding thread in the recording application process, which does not involve use of a screen rendering process in a system. Therefore, displayed content or notification content of another application program unrelated to the application is not recorded, thereby effectively satisfying an actual screen recording requirement of a user. In addition, as the foregoing screen recording apparatus is implemented by the recording application process corresponding to the application, rendering data may be directly obtained and used in the recording application process. In a case in which obtaining data in another application program is not involved, a system permission does not need to be applied for before screen recording, thereby simplifying an operation process of screen recording and improving implementation efficiency of a screen recording function.

The aspects of this disclosure further provide a computer device. The device may be a terminal device or a server. The terminal device and the server provided in the aspects of this disclosure are described below from a perspective of hardware materialization.

FIG. 8 is a schematic diagram of a structure of a terminal device according to an aspect of this disclosure. As shown in FIG. 8, for ease of description, only parts related to the aspects of this disclosure are shown. For specific technical details that are not disclosed, refer to the method part in the aspects of this disclosure. The terminal device may be any terminal device including a mobile phone, a tablet computer, a personal digital assistant (PDA), a point of sales (POS), and an on board computer, and the terminal device being a mobile phone is used as an example:

FIG. 8 is a block diagram of a part of a structure related to a terminal device according to an aspect of this disclosure. In FIG. 8, a computer includes components such as a radio frequency (RF) circuit 810, a memory 820, an input unit 830 (including a touch panel 831 and another input device 832), a display unit 840 (including a display panel 841), a sensor 850, an audio circuit 860 (connected to a speaker 861 and a microphone 862), a Wi-Fi module 870, a processor 880, and a power supply 890. A person skilled in the art can understand that, a structure of the computer shown in FIG. 8 does not constitute a limit on the computer, and may include components that are more or fewer than those shown in the figure, or may be a combination of some components, or different component deployment may be used.

The memory 820 may be configured to store a software program and module. The processor 880 runs the software program and module stored in the memory 820, to implement various functional applications and data processing of the computer. The memory 820 may mainly include a program storage area and a data storage area. The program storage area may store an operating system, an application program required by at least one function (such as a sound playback function and an image display function), and the like. The data storage area may store data (such as audio data and an address book) created based on use of the computer, and the like. In addition, the memory 820 may include a high speed random-access memory, and may also include a non-volatile memory, such as at least one magnetic disk memory, a flash memory, or another volatile solid-state memory.

The processor 880 is a control center of the computer, and is connected to each part of the computer by using various interfaces and lines. By running or executing the software program and/or module stored in the memory 820, and calling data stored in the memory 820, the processor 880 performs various functions and data processing of the computer. In some aspects, the processor 880 may include one or more processing units. In an example, the processor 880 may integrate an application processor and a modem processor. The application processor mainly processes an operating system, a user interface, an application program, and the like. The modem processor mainly processes wireless communication. The foregoing modem processor may either not be integrated into the processor 880.

In the aspects of this disclosure, the processor 880 included in the terminal device further has the following functions:
replicating, by using the primary rendering thread, rendering data stored in a backward buffer in the primary rendering thread to a bridge buffer, a shared texture identifier being bound to the bridge buffer;
obtaining, by using the secondary rendering thread, the rendering data from the bridge buffer based on the shared texture identifier, drawing the rendering data onto an input rendering surface provided by the encoding thread, to obtain an output rendering surface, and transmitting the output rendering surface to the encoding thread; and
encoding, by using the encoding thread, the output rendering surface, to obtain recorded video frame data.

In some aspects, the processor 880 is further configured to perform operations of any implementation of the screen recording method provided in the aspects of this disclosure.

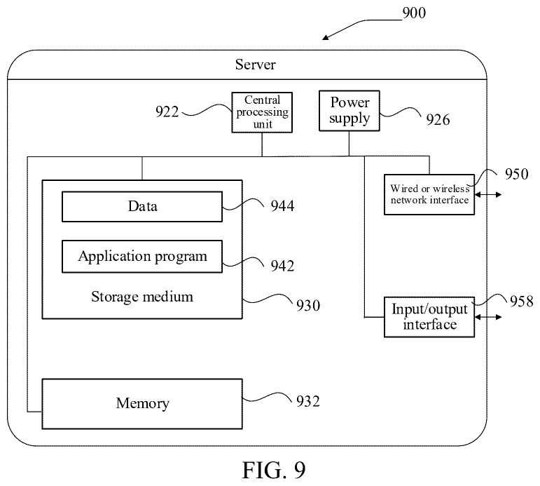

FIG. 9 is a schematic diagram of a structure of a server 900 according to an aspect of this disclosure. The server 900 may greatly differ as configuration or performance differs, and may include processing circuitry such as one or more central processing units (CPUs) 922 (for example, one or more processors) and memories 932 (for example, a non-transitory computer-readable storage medium), and one or more storage mediums 930 storing an application program 942 or data 944 (for example, one or more mass storage devices). The memories 932 and the storage mediums 930 may be configured for transient storage or permanent storage. A program stored in the storage medium 930 may include one or more modules (not marked in the figure), and each module may include a series of instruction operations on the server. Further, the central processing units 922 may be configured to communicate with the storage media 930, and perform, on the server 900, the series of instruction operations stored in the storage media 930.

The server 900 may further include one or more power supplies 926, one or more wired or wireless network interfaces 950, one or more input/output interfaces 958, and/or one or more operating systems, such as Windows Server™, Mac OS X™, Unix™, Linux™, or FreeBSD™.

The operations performed by the server in the foregoing aspects may be based on the server structure shown in FIG. 9.

The CPUs 922 are configured to perform the following operations:
replicating, by using the primary rendering thread, rendering data stored in a backward buffer in the primary rendering thread to a bridge buffer, a shared texture identifier being bound to the bridge buffer;
obtaining, by using the secondary rendering thread, the rendering data from the bridge buffer based on the shared texture identifier, drawing the rendering data onto an input rendering surface provided by the encoding thread, to obtain an output rendering surface, and transmitting the output rendering surface to the encoding thread; and
encoding, by using the encoding thread, the output rendering surface, to obtain recorded video frame data.

In some aspects, the CPUs 922 may further be configured to perform operations of any implementation of the screen recording method provided in the aspects of this disclosure.

The aspects of this disclosure further provide a computer-readable storage medium, such as a non-transitory computer-readable storage medium, configured to store a computer program. The computer program is configured to perform any implementation of the screen recording method in the foregoing aspects.

The aspects of this disclosure further provide a computer program product, including a computer program, and the computer program is stored in the computer-readable storage medium. A processor of a computer device reads the computer program from the computer-readable storage medium, and executes the computer program, so that the computer device performs any implementation of the screen recording method in the foregoing aspects.

It is noted that, for the purpose of convenient and brief description, for a specific working process of the foregoing system, apparatus, and unit, refer to a corresponding process in the foregoing method aspects, and details are not described herein again.

In the aspects provided in this disclosure, the disclosed system, apparatus, and method may be implemented in other manners. For example, the described apparatus aspect is merely an example. For example, division of the unit is merely logical function division and may be other division in actual implementation. For example, a plurality of units or components may be combined or integrated into another system, or some features may be ignored or not performed. In addition, displayed or discussed mutual couplings or direct couplings or communication connections may be implemented through some interfaces. Indirect couplings or communication connections between apparatuses or units may be implemented in electronic, mechanical, or other forms.

Units described as separate parts may or may not be physically separate, and parts displayed as units may or may not be physical units, may be located in one position, or may be distributed on a plurality of network units. Some of or all of the units may be selected based on actual requirements to achieve objectives of the solutions of the aspects.

In addition, functional units in the aspects of this disclosure may be integrated into one processing unit, or each of the units may exist alone physically, or two or more units may be integrated into one unit. The integrated unit may be implemented in a form of hardware, or may be implemented in a form of a software function unit.

If the integrated unit is implemented in a form of a software functional unit and sold or used as an independent product, the integrated unit may be stored in a computer-readable storage medium. Based on such an understanding, some or all of the technical solutions of this disclosure may be implemented in a form of a software product. The computer software product is stored in a storage medium and includes several instructions for instructing a computer device (which may be a personal computer, a server, or a network device) to perform all or some of the operations of the methods described in the aspects of this disclosure. The foregoing storage medium includes: any medium that can store a computer program, such as a USB flash drive, a mobile hard disk, a read-only memory (ROM), a random access memory (RAM), a magnetic disk, or an optical disc.

In this disclosure, “at least one” means one or more, and “a plurality of” means two or more. The term “and/or” describes an association between associated objects and represents that three associations may exist. For example, “A and/or B” may indicate: only A exists, only B exists, and both A and B exist, where A and B may be singular or plural. The character “/” generally represents an “or” relationship between the associated objects. “At least one of the following items” or a similar expression means any combination of these items, including a single item or any combination of a plurality of items. For example, at least one of a, b, or c may represent a, b, c, “a and b”, “a and c”, “b and c”, or “a, b, and c”, where a, b, and c may be singular or plural.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing aspects are merely provided for describing examples of the technical solutions of this disclosure, not to limit the scope of this disclosure. Although this disclosure is described with reference to the foregoing aspects, a person of ordinary skill in the art should understand that modifications can still be made to the technical solutions described in the foregoing aspects, or equivalent replacements can be made to some technical features thereof, without departing from a spirit and scope of the technical solutions of the aspects of this disclosure.

What is claimed is:

1. A screen recording method, comprising:
executing a recording application process corresponding to an application, the recording application process including a primary rendering thread, a secondary rendering thread, and an encoding thread, the secondary rendering thread and the encoding thread being enabled based on a screen recording operation;
copying, through the primary rendering thread, rendering data stored in a back buffer of the primary rendering thread to a bridge buffer, a shared texture identifier being bound to the bridge buffer;
obtaining, through the secondary rendering thread, the rendering data from the bridge buffer based on the shared texture identifier;
drawing the rendering data onto an input rendering surface provided by the encoding thread to generate an output rendering surface; and
encoding, through the encoding thread, the output rendering surface to generate video frame data.

2. The method according to claim 1, further comprising:
creating, through the secondary rendering thread, a secondary graphics context based on a primary graphics context corresponding to the primary rendering thread, wherein
the primary graphics context is a parent graphics context of the secondary graphics context, and
the shared texture identifier created in the primary rendering thread corresponding to the parent graphics context is accessible to the secondary rendering thread corresponding to the secondary graphics context.

3. The method according to claim 1, further comprising:
when the primary rendering thread detects that the shared texture identifier and the bridge buffer are not initialized:
creating, through the primary rendering thread, the shared texture identifier and the bridge buffer,
binding the shared texture identifier to the bridge buffer, and
performing the copying of the rendering data from the back buffer to the bridge buffer; and
when the primary rendering thread detects that the shared texture identifier and the bridge buffer are initialized:
performing the copying of the rendering data from the back buffer to the bridge buffer.

4. The method according to claim 1, wherein the copying comprises:
setting, through the primary rendering thread, the bridge buffer as a current write buffer of the primary rendering thread;
setting, through the primary rendering thread, the back buffer as a current read buffer in the primary rendering thread; and
executing, through the primary rendering thread, a buffer replication function to copy the rendering data from the current read buffer to the current write buffer.

5. The method according to claim 4, wherein the executing the buffer replication function comprises:
copying, by executing the buffer replication function, color data stored in a color buffer of the current read buffer to the current write buffer.

6. The method according to claim 4, further comprising:
detecting a screen recording stop operation; and
performing, through the primary rendering thread, recovery processing on a read frame buffer target and a write frame buffer target of the primary rendering thread to restore the read frame buffer target and the write frame buffer target to values prior to the screen recording operation, wherein
the read frame buffer target indicates the current read buffer and the write frame buffer target indicates the current write buffer.

7. The method according to claim 1, wherein the drawing comprises:
building, through the secondary rendering thread, a shader;
generating, through the shader, a rendering result based on a mapping relationship between vertex coordinates of the input rendering surface and texture coordinates of the rendering data; and
outputting the rendering result to the input rendering surface to generate the output rendering surface.

8. The method according to claim 1, further comprising:
creating, through the encoding thread, a media encoder;
creating, through the media encoder, the input rendering surface; and
outputting the input rendering surface from the media encoder to the secondary rendering thread; and
the encoding comprises:
encoding, through the media encoder, the output rendering surface to generate the video frame data.

9. The method according to claim 1, further comprising:
obtaining a recorded video size set through the application, the recorded video size indicating a size of video frames to be generated through screen recording;
creating, through the encoding thread, the input rendering surface corresponding to the recorded video size; and
providing the input rendering surface to the secondary rendering thread to generate the video frame data corresponding to the recorded video size.

10. The method according to claim 1, further comprising:
obtaining a recorded video frame rate set through the application, the recorded video frame rate indicating a frame rate of video to be generated through screen recording; and
the drawing comprises:
drawing, through the secondary rendering thread, the rendering data onto the input rendering surface according to a drawing periodicity based on the recorded video frame rate to generate the output rendering surface.

11. A screen recording apparatus, comprising:
processing circuitry configured to:
execute a recording application process corresponding to an application, the recording application process including a primary rendering thread, a secondary rendering thread, and an encoding thread, the secondary rendering thread and the encoding thread being enabled based on a screen recording operation;
copy, through the primary rendering thread, rendering data stored in a back buffer of the primary rendering thread to a bridge buffer, a shared texture identifier being bound to the bridge buffer;
obtain, through the secondary rendering thread, the rendering data from the bridge buffer based on the shared texture identifier;
draw the rendering data onto an input rendering surface provided by the encoding thread to generate an output rendering surface; and
encode, through the encoding thread, the output rendering surface to generate video frame data.

12. The apparatus according to claim 11, wherein
the processing circuitry is configured to create, through the secondary rendering thread, a secondary graphics context based on a primary graphics context corresponding to the primary rendering thread,
the primary graphics context is a parent graphics context of the secondary graphics context, and
the shared texture identifier created in the primary rendering thread corresponding to the parent graphics context is accessible to the secondary rendering thread corresponding to the secondary graphics context.

13. The apparatus according to claim 11, wherein the processing circuitry is configured to:
when the primary rendering thread detects that the shared texture identifier and the bridge buffer are not initialized:
create, through the primary rendering thread, the shared texture identifier and the bridge buffer,
bind the shared texture identifier to the bridge buffer, and
perform the copying of the rendering data from the back buffer to the bridge buffer; and
when the primary rendering thread detects that the shared texture identifier and the bridge buffer are initialized:
perform the copying of the rendering data from the back buffer to the bridge buffer.

14. The apparatus according to claim 11, wherein the processing circuitry is configured to:
set, through the primary rendering thread, the bridge buffer as a current write buffer of the primary rendering thread;
set, through the primary rendering thread, the back buffer as a current read buffer in the primary rendering thread; and
execute, through the primary rendering thread, a buffer replication function to copy the rendering data from the current read buffer to the current write buffer.

15. The apparatus according to claim 14, wherein the processing circuitry is configured to:
copy, by executing the buffer replication function, color data stored in a color buffer of the current read buffer to the current write buffer.

16. The apparatus according to claim 14, wherein
the processing circuitry is configured to:
detect a screen recording stop operation; and
perform, through the primary rendering thread, recovery processing on a read frame buffer target and a write frame buffer target of the primary rendering thread to restore the read frame buffer target and the write frame buffer target to values prior to the screen recording operation, and
the read frame buffer target indicates the current read buffer and the write frame buffer target indicates the current write buffer.

17. The apparatus according to claim 11, wherein the processing circuitry is configured to:
build, through the secondary rendering thread, a shader;
generate, through the shader, a rendering result based on a mapping relationship between vertex coordinates of the input rendering surface and texture coordinates of the rendering data; and
output the rendering result to the input rendering surface to generate the output rendering surface.

18. The apparatus according to claim 11, wherein the processing circuitry is configured to:
create, through the encoding thread, a media encoder;
create, through the media encoder, the input rendering surface;
output the input rendering surface from the media encoder to the secondary rendering thread; and
encode, through the media encoder, the output rendering surface to generate the video frame data.

19. The apparatus according to claim 11, wherein the processing circuitry is configured to:
obtain a recorded video size set through the application, the recorded video size indicating a size of video frames to be generated through screen recording;
create, through the encoding thread, the input rendering surface corresponding to the recorded video size; and
provide the input rendering surface to the secondary rendering thread to generate the video frame data corresponding to the recorded video size.

20. A non-transitory computer-readable storage medium storing instructions which, when executed by a processor, cause the processor to perform:
executing a recording application process corresponding to an application, the recording application process including a primary rendering thread, a secondary rendering thread, and an encoding thread, the secondary rendering thread and the encoding thread being enabled based on a screen recording operation;
copying, through the primary rendering thread, rendering data stored in a back buffer of the primary rendering thread to a bridge buffer, a shared texture identifier being bound to the bridge buffer;
obtaining, through the secondary rendering thread, the rendering data from the bridge buffer based on the shared texture identifier;
drawing the rendering data onto an input rendering surface provided by the encoding thread to generate an output rendering surface; and
encoding, through the encoding thread, the output rendering surface to generate video frame data.
